(19) United States
(12) Patent Application Publication
(10) Pub. No.: US 2023/0213137 A1
(43) Pub. Date: Jul. 6, 2023

(54) COMPRESSED SHEETS WITH HIGH STRETCHABILITY

(71) Applicant: Jhonny R. Ramirez Dala, Miramar, FL (US)

(72) Inventor: Jhonny R. Ramirez Dala, Miramar, FL (US)

(21) Appl. No.: 17/646,694

(22) Filed: Dec. 31, 2021

(51) Int. Cl. F16L 59/14; F16L 9/12; F16L 59/02

(52) U.S. Cl. CPC F16L 59/14; F16L 9/121; F16L 59/029

(57) ABSTRACT

A sheet of material is crumpled and flattened so that it is longitudinally compressed while remaining substantially uncompressed in the lateral direction. Once so formed, the sheet may be stretched to conform to complex three-dimensional shapes. When applied to thermally insulated piping, for example, such sheets may serve as barriers to the movement of water in the insulation system.

### FIELD OF THE INVENTION

The present invention relates generally to sheets of material, and, more particularly, to sheets of material compressed by crumpling and being manually stretchable.

### BACKGROUND OF THE INVENTION

Pipes intended to transport hot fluids are often surrounded by thermal insulation to keep the fluids in the pipes at or near temperature during transport. The thermal insulation helps to save energy while also helping to control condensation, eliminate freezing, reduce noise, and keep personnel safe from contact with hot surfaces. Nevertheless, despite the several advantages of using thermal insulation on hot pipes, there are also downsides. Water may infiltrate a thermal insulation system. Once inside, the water may variously evaporate, condense, move by convection and capillary action, and settle in response to gravity. Eventually, vapor-phase water tends to rise or move upwards along the vertical runs of piping and get trapped in the upper locations, while liquid-water tends to settle mainly in the horizontal runs. The infiltrating water creates at least two major issues. First, liquid and frozen water increases the thermal conductivity of the thermal insulation, reducing the insulation's effectiveness and leading to energy loss. Second, the water, particularly when pooled, promotes corrosion of the pipes. Beyond economic losses, corrosion can ultimately lead to catastrophic failures and even loss of life.

There is, as result, a need to develop solutions for removing water from the thermal insulation surrounding hot pipes. In conjunction with these solutions, there is also a need for simple and effective ways by which thermal insulation systems can be sectorized so as to confine the water to one sector or another. Once sectorized in this manner, water removal becomes substantially easier.

### SUMMARY OF THE INVENTION

Embodiments of the present invention address the above-identified need by providing sheets of material that are crumpled and flattened so as to be longitudinally compressed while remaining substantially uncompressed in the lateral direction. Once so formed, the sheets may be stretched to conform to complex three-dimensional shapes. When applied to thermally insulated piping, for example, such sheets may serve as barriers to the movement of water in the insulation system.

Aspects of the invention are directed to an apparatus comprising a sheet. At least a portion of the sheet is compressed in a longitudinal direction by crumpling, capable of being manually stretched in the longitudinal direction, and substantially uncompressed in a lateral direction.

Additional aspects of the invention are directed to a method for producing a compressed sheet. The sheet is drawn at a first velocity in a longitudinal direction. The sheet is then drawn at a second velocity in the longitudinal direction slower than the first velocity to cause at least a portion of the sheet to be compressed in the longitudinal direction by crumpling. The sheet remains substantially uncompressed in a lateral direction.

### BRIEF DESCRIPTION OF THE DRAWINGS

These and other features, aspects, and advantages of the present invention will become better understood with regard to the following description, appended claims, and accompanying drawings where:

FIGS. 1A-1C show top elevational views of a sheet in accordance with an illustrative embodiment of the invention in a fully compressed state, a uniformly stretched state, and a state wherein the sheet is stretched to varying extents in three different regions, respectively;

FIG. 2 shows a side perspective view of the sheet from FIGS. 1A-1C covering a cylindrical pipe with two layers of thermal insulation arranged in a staggered configuration;

FIG. 3A shows a partially-broken side perspective view of the sheet from FIGS. 1A-1C acting as a water barrier for a cylindrical pipe with a thermal insulation layer;

FIG. 3B shows the FIG. 3A elements with the addition of tie wraps;

FIG. 4 shows a side perspective view of a manufacturing apparatus in accordance with an illustrative embodiment of the invention capable of producing the sheet from FIGS. 1A-1C; and

FIGS. 5-11 show aspects of the FIG. 4 manufacturing apparatus and a continuous sheet at various points in manufacturing.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

As used herein and in the appended claims, a “sheet” means a sheet of material and may be composed of a single layer of material or more than one layer of material, as in, for example, a laminate. A sheet has a “lateral direction” and a “longitudinal direction,” which are orthogonal to one another in the plane of the sheet. The “lateral direction” of the sheet is not necessarily longer or shorter than the “longitudinal direction” of the sheet. “Crumpled” or “compressed by crumpling” means crushed to form a disordered network of creases and wrinkles. A crumpled sheet can be distinguished from, for example, a corrugated sheet because a corrugated sheet has an ordered set of peaks and valleys. “Capable of being manually stretched” in a given direction means capable of being stretched in the given direction by a human of average strength with only their hands to the extent that the resultant length in the given direction is increased by more than two-times. “Substantially uncompressed” in a given direction means uncompressed in the given direction, or only compressed in the given direction such that the resultant length in the given direction is not decreased by more than ten percent. “Water” means water in the liquid phase (i.e., liquid water) and water in the gaseous phase (i.e., steam and water vapor in air). “Thermal insulation” includes insulation systems both with and without outer jackets. Lastly, an “annular surface” is a surface in the shape of an annulus.

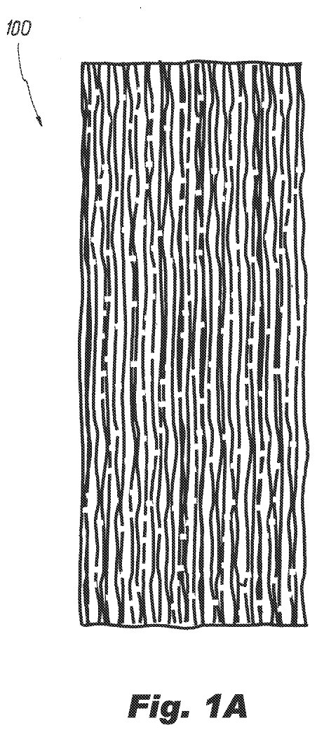

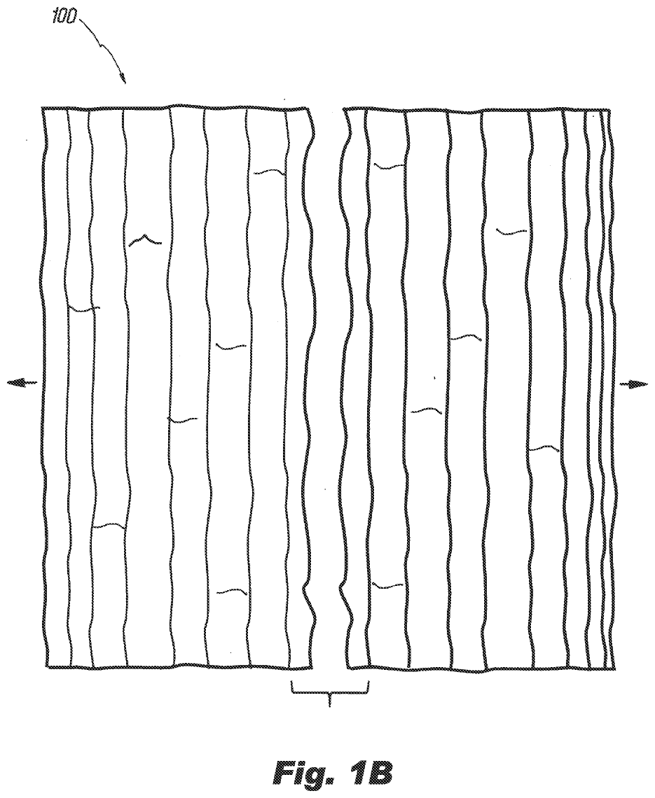

Embodiments of the invention are directed to a sheet of material that is compressed in a manner that makes it well suited for use as a barrier material for insulated piping and other like applications. FIGS. 1A-1C show aspects of a sheet 100 in accordance with an illustrative embodiment of the invention. FIG. 1A shows a top elevational view of the sheet 100 while the sheet 100 is in its fully compressed state, while FIG. 1B shows a top elevational view of the sheet 100 with the sheet 100 uniformly stretched from its fully compressed state. FIG. 1C shows a top elevational view of the sheet 100 stretched to varying extents in three different regions.

In its fully compressed state in FIG. 1A, the sheet 100 is compressed in a longitudinal direction (left-right in the figure) by crumpling while being substantially uncompressed in the lateral direction (up-down in the figure). That is, the sheet 100 is crushed in the longitudinal direction to form a disordered network of creases and wrinkles. The sheet 100 is also compressed in a direction transverse to the longitudinal and lateral directions so as to be flattened.

So formed, the sheet 100 in FIG. 1A is capable of being manually stretched in the longitudinal direction to achieve the stretched states indicated in FIGS. 1B and 1C. Experimentation with sheets like the sheet 100 shown in FIGS. 1A-1C suggest that sheets compressed by crumpling in the longitudinal direction and then flattened are capable of being manually stretched in the longitudinal direction by more than ten times their fully compressed length. One prototype in aluminum indicated stretchability greater than eleven-times the initial length. Notably, stretching in the longitudinal direction need not occur uniformly across the entire sheet 100. That is, in one or more applications, an upper portion of the sheet 100 could be stretched to a greater or lesser degree than a lower portion of the sheet 100 (see, e.g., FIG. 1C).

The sheet 100, and, more generally, sheets in accordance with aspects of the invention, thereby become a convenient and effective means by which to cover complicated three-dimensional (3D) objects. One application for the sheet 100 is to provide a water barrier in thermal insulation systems used with hot piping. Thermal insulation on hot piping helps to save energy while also helping to control condensation, eliminate freezing, reduce noise, and keep personnel safe from contact with hot surfaces. Nevertheless, water may infiltrate a thermal insulation system and, once inside, may increase the thermal conductivity of the thermal insulation and/or promote corrosion. Water barriers in the thermal insulation confine the water to one sector or another. Once sectorized in this manner, water removal becomes substantially easier because whatever means is utilized to remove the water need only act on the limited volume within its sector and any water will not spread from one sector to another.

The sheet 100 may comprise a number of different materials including, as just a few examples, a metal, a polymer, an elastomer, a closed cell foam, a composite, a fiber, a fabric, or some combination thereof. The sheet 100 may also comprise more than one layer of material, as in a laminate. Material thickness may be from, for example, 0.013 millimeters (mm) to 10 mm. If the sheet 100 is to be used as a water barrier, the sheet is preferably impermeable to water. For example, if the sheet 100 is to act as a water barrier, the sheet 100 may comprise aluminum foil coated in a polymer. While contact between aluminum and stainless-steel piping is generally discouraged because of concerns with galvanic corrosion, the polymer coating helps to mitigate this issue. At the same time, aluminum foil is well suited to compression by crushing in the manner set forth herein due to its malleability and has a very low water vapor transmission rate (WVTR).

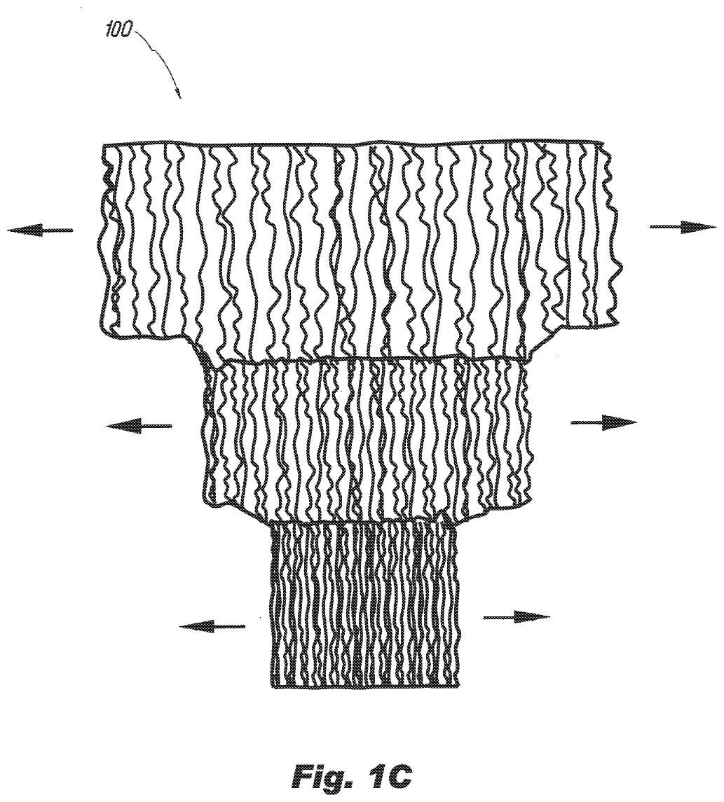

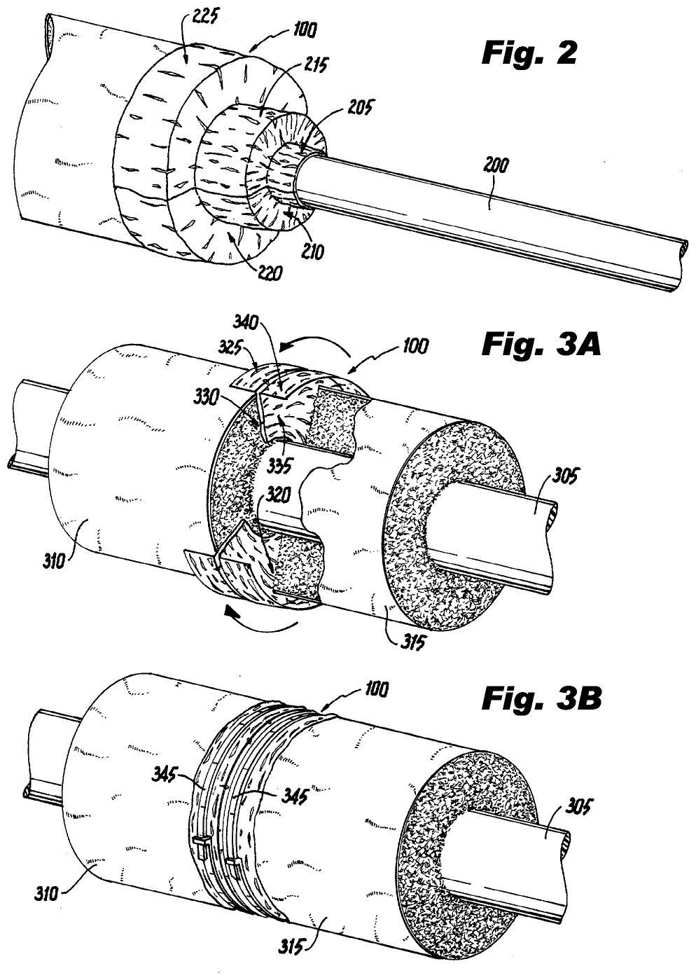

To illustrate the covering capability of the sheet 100, FIG. 2 shows a side perspective view of the sheet 100 covering the complex geometry presented by a cylindrical pipe 200 with two layers of thermal insulation arranged in a staggered configuration. The piping system includes an exposed portion of the cylindrical pipe 200 that remains uncovered by thermal insulation, a second portion of the cylindrical pipe 200 that is covered by a first insulation layer, and a third portion of the cylindrical pipe 200 that is covered by both the first insulation layer and a second insulation layer. Broken down, these various elements define five surfaces including three cylindrical exterior surfaces, two of which terminate in a respective annular surface. As indicated in FIG. 2, the sheet 100 is capable of covering this complex geometry given the sheet's unique stretching capability. A first portion of the sheet 205 overlies the exposed portion of the cylindrical pipe 200, a second portion of the sheet 210 overlies a first annular surface, a third portion of the sheet 215 overlies a first cylindrical exterior surface, a fourth portion of the sheet 220 overlies a second annular surface, and a fifth portion of the sheet 225 overlies a second cylindrical exterior surface. Despite the complexity of the required shape, the sheet 100 remains continuous throughout. If desired, an adhesive may be added to either the surfaces being covered or to the sheet to aid with fixation.

FIG. 3A goes on to show a top partially-broken perspective view of the sheet 100 in another application, namely, as a water barrier in a system comprising a cylindrical pipe 305 with a first thermal insulation layer 310 and a second thermal insulation layer 315 overlying the cylindrical pipe 305. The second thermal insulation layer 315 is in spaced relation to the first thermal insulation layer 310 to define a notch 320 therebetween that is radial to the cylindrical pipe 305. So configured, the first thermal insulation layer 310 defines a first cylindrical exterior surface terminating in a first annular surface. Likewise, the second thermal insulation layer defines a second cylindrical exterior surface terminating in a second annular surface. The second annular surface faces the first annular surface.

To act as a water barrier, the sheet 100 is molded to occupy the notch 320 between the first thermal insulation layer 310 and the second thermal insulation layer 315. More particularly, a first portion of the sheet 325 overlies the first cylindrical exterior surface, a second portion of the sheet 330 overlies the first annular surface, a third portion of the sheet 335 overlies the second annular surface, and a fourth portion of the sheet 340 overlies the second cylindrical exterior surface. For purposes of illustration, the ends of the sheet 100 are pulled outward somewhat in FIG. 3A, but, in use, the sheet 100 would provide full coverage around the cylindrical pipe 305. Water is thereby impeded from travelling from the first thermal insulation layer 310 into the second thermal insulation layer 315.

As indicated before, an adhesive may be added to the surfaces being covered or to the sheet 100 to aid with adhesion. Alternatively, bands of some kind may be utilized to hold the sheet 100 in place. FIG. 3B shows a top elevational view of the sheet 100 acting as a water barrier for the first thermal insulation layer 310 and the second thermal insulation layer 315 in the manner discussed above for FIG. 3A. However, in FIG. 3B, two optional tie wraps 345 are implemented to aid with fixation. Additionally or alternatively, a band may be applied to the interface of the second and third portions of the sheet 330, 335 to hold the sheet 100 tightly against the cylindrical pipe 305.

Given the unique stretchability of the sheet 100, the sheet 100 can be retroactively implemented in the manner shown in FIG. 3A to piping with an already-existing, uninterrupted thermal insulation layer. Initially, a notch like the notch 320 may be cut into the thermal insulation layer where the water barrier is intended so as to divide the thermal insulation layer into two parts. Next, a sheet like the sheet 100 may be molded into the notch to achieve a condition like that shown in FIG. 3A. Banding may be utilized to aid with fixation (FIG. 3B).

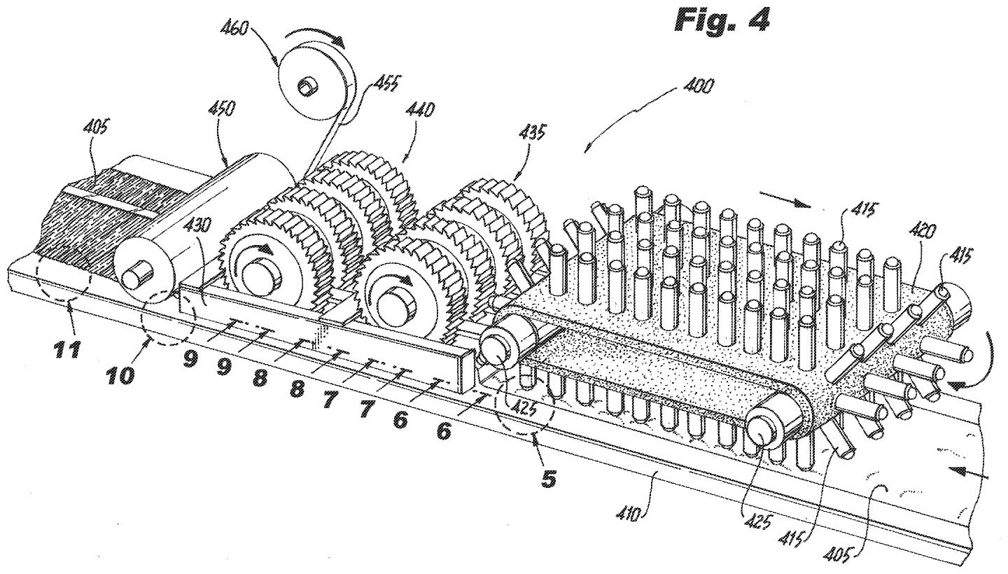

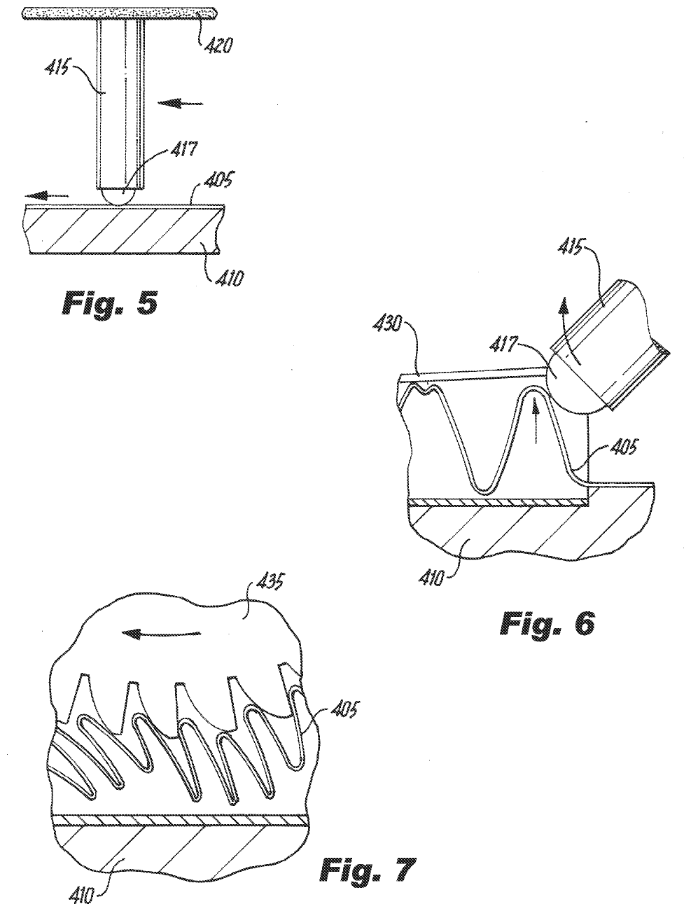

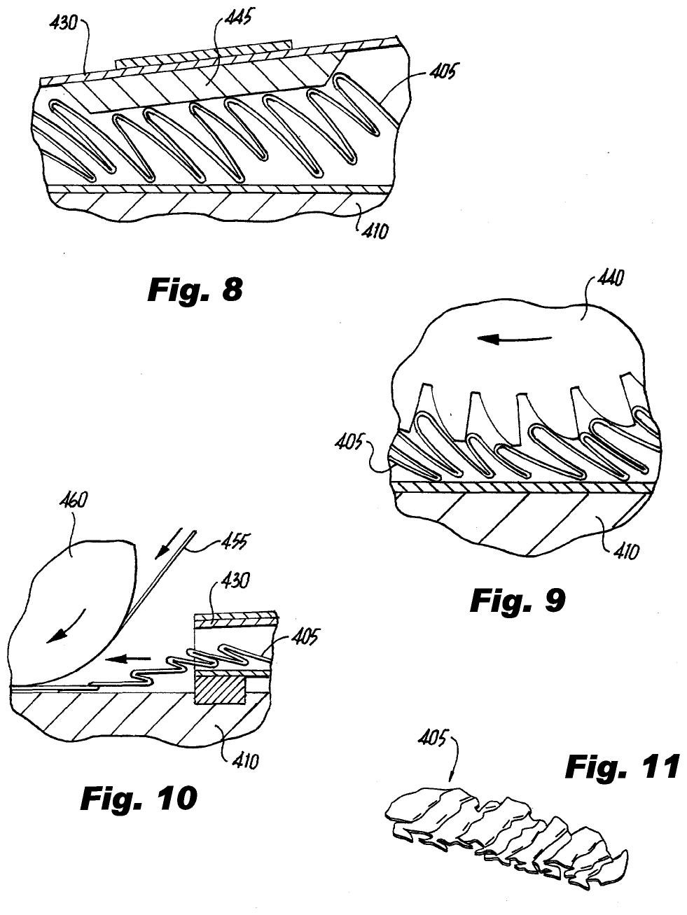

FIG. 4 shows a side perspective view of a manufacturing apparatus 400, which may be utilized to convert a continuous, initially-flat sheet of material (hereinafter the continuous sheet 405) into a sheet having the properties of the sheet 100. FIGS. 5-11 show aspects of the manufacturing apparatus 400 and the continuous sheet 405 at the various points in the processing indicated in FIG. 4.

The continuous sheet 405 enters the manufacturing apparatus 400 from the right as a flat sheet laying on a table 410. Here, the continuous sheet 405 is driven towards the left in the longitudinal direction by a plurality of fingers 415, which are attached to a belt 420 that spans between two first rotating drums 425. Each finger 415 terminates in a respective rubber tip 417 that contacts the continuous sheet 405 across the table 410. In this manner, the continuous sheet 405 is imparted with a first linear velocity in the longitudinal direction across the table 410 by the two first rotating drums 425.

Next, the continuous sheet 405 enters a chamber 430, where it encounters, at first, four second rotating drums 435, and, later, four third rotating drums 440, which act to further draw the continuous sheet 405 in the longitudinal direction. As the second and third rotating drums 435, 440 rotate, portions of these second and third rotating drums 435, 440 enter the chamber 430 through openings in the top of the chamber 430. The second and third rotating drums 435, 440 have teeth that help to move the continuous sheet 405 along without damage to the continuous sheet 405. Of course, a greater number or a fewer number of the second and third rotating drums 435, 440 may be utilized if the continuous sheet 405 is wider or narrower (in the lateral direction) than that shown in the FIG. 4.

The second and third rotating drums 435, 440, in combination with the chamber 430, act to impart the continuous sheet 405 with much of the desired compression by crumpling in the longitudinal direction. To achieve this crumpling, the second rotating drums 435 impart a second linear velocity to the continuous sheet 405 lower than the first linear velocity, and, subsequently, the third rotating drums 440 impart a third linear velocity to the continuous sheet 405 slower than the second linear velocity. In response to the retarding of its velocity, the continuous sheet 405 begins to collect on itself as indicated in FIGS. 6-9. At the same time, the chamber 430 has a roof portion 445 under which the continuous sheet 405 must pass that decreases in height, keeping the continuous sheet 405 close to the table 410 and limiting vertical growth of the continuous sheet 405 in a direction vertical to the table 410.

Finally, after leaving the chamber 430, the continuous sheet 405 encounters a flattening drum 450 that compresses the continuous sheet 405 in a direction transverse to the longitudinal and lateral directions (i.e., in a direction normal to the table 410) to flatten the continuous sheet 405. In addition, the flattening drum 450 applies a strip of tape 455 from a roll of tape 460 to the now-compressed continuous sheet 405 to aid with maintaining the continuous sheet 405 in its compressed state during storage and shipping. Like the sheet 100, the continuous sheet 405 at this point is compressed in a longitudinal direction by crumpling while being substantially uncompressed in the lateral direction. Moreover, like the sheet 100, the continuous sheet 405 is also compressed in a direction transverse to the longitudinal and lateral directions so as to be flattened. The continuous sheet 405 may be rolled or stacked for shipping, as desired.

Sheets 100, 405, and more generally, sheets in accordance with aspects of the invention, have several advantages over other materials. When compressed by crumpling, for example, the sheets described herein are capable of being manually stretched in the longitudinal direction by many times their fully compressed length. Modeling suggests that compressed sheets with stretchabilities of greater than fifty-times are possible. The sheets thereby become a good candidate for use in many applications requiring the covering of complex 3D shapes. FIGS. 3A and 3B, for example, show how readily the sheet 100 can be applied as a water barrier in already-existing thermally insulated piping. No breaking of the sheet 100 occurs given the unique stretching properties of the sheet 100.

In comparison, a material compressed by, for example, corrugation does not exhibit nearly the stretchability of the crumpled sheets described herein. It is estimated that a corrugated sheet may be stretched by some 1.5-times its compressed length given the regular pattern of peaks and valleys characteristic of corrugation. This stretchability is clearly much lower than the stretchability available for sheets compressed by crumpling. When applied to an exacting application such as that shown in FIGS. 3A and 3B, a corrugated sheet would likely break, losing its ability to act as an effective barrier for water.

It should again be emphasized that the above-described embodiments of the invention are intended to be illustrative only. Other embodiments can use different types and arrangements of elements for implementing the described functionality. These numerous alternative embodiments within the scope of the appended claims will be apparent to one skilled in the art. The spirit and scope of the appended claims should not be limited solely to the description of the preferred embodiments contained herein.

Moreover, all the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

What is claimed is:

1. An apparatus comprising a sheet, at least a portion of the sheet compressed in a longitudinal direction by crumpling, capable of being manually stretched in the longitudinal direction, and substantially uncompressed in a lateral direction.

2. The apparatus of claim 1, wherein the at least a portion of the sheet compressed in the longitudinal direction is also compressed in a direction transverse to the longitudinal direction and the lateral direction so as to be flattened.

3. The apparatus of claim 1, wherein the sheet comprises a metal, a polymer, an elastomer, a closed cell foam, a composite, a fiber, or a fabric.

4. The apparatus of claim 1, wherein the sheet comprises a laminate.

5. The apparatus of claim 1, wherein the sheet comprises a metal coated in a polymer.

6. The apparatus of claim 1, wherein the sheet is impermeable to water.

7. The apparatus of claim 1, wherein the at least a portion of the sheet compressed in the longitudinal direction is capable of being manually stretched in the longitudinal direction by more than ten-times its length when compressed.

8. The apparatus of claim 1, further comprising tape applied to the sheet.

9. The apparatus of claim 1, further comprising:
a cylindrical pipe; and
a thermal insulation layer overlying the cylindrical pipe with an exposed portion of the cylindrical pipe remaining uncovered by the thermal insulation layer, the thermal insulation layer defining a cylindrical exterior surface terminating in an annular surface;
wherein a first portion of the sheet overlies the exposed portion of the cylindrical pipe, a second portion of the sheet overlies the annular surface, and a third portion of the sheet overlies the cylindrical exterior surface.

10. The apparatus of claim 1, further comprising:
a cylindrical pipe;
a first thermal insulation layer overlying the cylindrical pipe and defining a first cylindrical exterior surface terminating in a first annular surface; and
a second thermal insulation layer overlying the cylindrical pipe in spaced relation to the first thermal insulation layer, the second thermal insulation layer defining a second cylindrical exterior surface terminating in a second annular surface facing the first annular surface;
wherein a first portion of the sheet overlies the first cylindrical exterior surface, a second portion of the sheet overlies the first annular surface, a third portion of the sheet overlies the second annular surface, and a fourth portion of the sheet overlies the second cylindrical exterior surface.

11. The apparatus of claim 10, wherein the sheet impedes water from traversing between the first thermal insulation layer and the second thermal insulation layer.

12. A method comprising:
drawing a sheet at a first velocity in a longitudinal direction; and
then drawing the sheet at a second velocity in the longitudinal direction slower than the first velocity to cause at least a portion of the sheet to be compressed in the longitudinal direction by crumpling;
wherein the sheet remains substantially uncompressed in a lateral direction.

13. The method of claim 12, further comprising compressing the sheet in a direction transverse to the longitudinal direction and the lateral direction to flatten the sheet.

14. The method of claim 12, further comprising drawing the sheet at a third velocity in the longitudinal direction after drawing the sheet at the second velocity, the third velocity slower than the second velocity.

15. The method of claim 12, wherein drawing the sheet at the first velocity is achieved at least in part utilizing one or more first rotating drums and drawing the sheet at the second velocity is achieved at least in part utilizing one or more second rotating drums.

16. The method of claim 12, wherein the sheet is drawn through a chamber in the longitudinal direction, the chamber having a height under which the sheet must pass that decreases.

17. The method of claim 12, further comprising applying tape to the sheet.

18. The method of claim 12, wherein the sheet comprises a metal, a polymer, an elastomer, a closed cell foam, a composite, a fiber, or a fabric.

19. The method of claim 12, wherein the sheet is impermeable to water.

20. The method of claim 12, wherein the at least a portion of the sheet compressed in the longitudinal direction by crumpling is capable of being manually stretched in the longitudinal direction.
